(19) United States
(12) Patent Application Publication
(10) Pub. No.: US 2020/0323201 A1
(43) Pub. Date: Oct. 15, 2020

(54) HERBICIDE COMPOSITIONS AND METHODS OF CONTROLLING GROWTH OF PLANTS

(71) Applicant: Timothy St. Germain, Guelph (CA)

(72) Inventor: Timothy St. Germain, Guelph (CA)

(21) Appl. No.: 16/849,933

(22) Filed: Apr. 15, 2020

Related U.S. Application Data
(60) Provisional application No. 62/833,889, filed on Apr. 15, 2019.

(51) Int. Cl. A01N 35/06

(52) U.S. Cl. CPC A01N 35/06

(57) ABSTRACT

Herbicide compositions and methods effective in controlling growth of plants are described herein. The herbicide compositions include an herbicidally effective amount of (N)R-1,4-naphthaquinone or an agriculturally acceptable salt thereof, wherein N is of the value 2-5 and R is a functional group.

### CROSS-REFERENCE

This application claims the benefit of U.S. Provisional Patent Application No. 62/833,889 entitled “Herbicide method and composition for controlling weeds using R-4-5-naphthalenedione where R is a chemical functional group”, filed Apr. 15, 2019, the entire contents of which are incorporated herein.

### TECHNICAL FIELD

The embodiments disclosed herein relate to herbicide compositions and methods for controlling the growths of plants, and specifically to herbicide compositions and methods of controlling growth of weeds and herbicide resistant weeds.

### BACKGROUND

Conventional synthetic herbicides come with an ecological cost, but due to their efficacy, they have been widely used in agriculture. While more ‘environmentally friendly’ alternative herbicides exist, and have been exploited to some extent, they are typically not as efficacious as chemical synthetics.

Recently, there has been increased growth in the number of herbicide resistant weeds. Herbicide resistant weeds are a consequence of basic evolutionary processes. These weeds survive herbicide application at doses that usually provide effective control of their growth, thereby making it difficult to control their growth.

As different chemical resistant weeds emerge, and as their spread throughout different regions of the world accelerates, a once stable and inexpensive food supply is becoming threatened. Herbicide companies have therefore been searching for new mode-of-action chemistries to combat these problems. Unfortunately, new mode-of-action chemistries are very difficult and expensive to develop.

There is therefore a need for herbicide compositions and methods for controlling growth of weeds, and specifically for controlling the growth of herbicide resistant weeds.

### SUMMARY

In one broad aspect, an herbicide composition effective in controlling growth of plants is described herein. The herbicide composition includes a herbicidally effective amount of (N)R-1,4-naphthaquinone or an agriculturally acceptable salt thereof; wherein N is of the value 2-5 and R is a functional group. The functional group includes any one of, or any combination of, the following functional groups:
i. alkane;
ii. alkene;
iii. alkyne;
iv. benzene;
v. amine;
vi. alcohol;
vii. ether;
viii. alkyl halide;
ix. thiol;
x. aldehyde;
xi. ketone;
xii. ester;
xiii. carboxylic acid;
xiv. amide; or
xv. hydroxyl.

In at least one embodiment, the plants include undesirable vegetation.

In at least one embodiment, the undesirable vegetation includes at least one herbicide resistant weed.

In at least one embodiment, the at least one herbicide resistant weed includes at least one glyphosate-based herbicide resistant weed.

In at least one embodiment, the at least one herbicide resistant weed includes at least one herbicide resistant weed that is resistant to one or more of the following groups of herbicides:
i. Group 1: ACCase Inhibitors;
ii. Group 2: ACL Inhibitors;
iii. Group 3: Root Growth Inhibitors;
iv. Group 4: Plant Growth Regulators;
v. Group 5,6,7: Photosynthesis (PSIII) Inhibitors;
vi. Group 8 and 15: Shoot Growth Inhibitors;
vii. Group 9: Aromatic Amino Acid Inhibitors;
viii. Group 10: Glutamine Synthesis Inhibitors;
ix. Group 12,23,37: Pigment Synthesis Inhibitors;
x. Group 14: PPO Inhibitors; and
xi. Group 22: Photosynthesis Inhibitors.

In at least one embodiment, the at least one herbicide resistant weed includes a herbicide resistant weed of one or more of the following families of weeds:
i. Amaranthacaea (amaranth family);
ii. Anacardiaceae (poison-ivy family);
iii. Apiaceae (also referred to as Umbelliferae);
iv. Asclepiadaceae (milkweed family);
v. Asteraceae family (also referred to as Compositae);
vi. Balsaminaceae (touch-me-not family);
vii. Berberidaceae (barberry family);
viii. Boraginaceae (borage family);
ix. Brassicaceae (also referred to as Cruciferae);
x. Butomaceae (flowering rush family);
xi. Cannabaceae (cannabis family);
xii. Caprifoliaceae (honeysuckle family);
xiii. Caryophyllaceae (pink family);
xiv. Chenopodiaceae (goosefoot family);
xv. Compositae (composite family);
xvi. Convolvulaceae (morning-glory family);
xvii. Crassulaceae (orpine family);
xviii. Cruciferae (mustard family);
xix. Cucurbitaceae (cucumber family);
xx. Cyperaceae (sedge family);
xxi. Equisetaceae (horsetail family);
xxii. Euphorbiaceae (spurge family);
xxiii. Fabaceae (also referred to as Leguminosae);
xxiv. Gram ineae (also referred to as Poaceae; grass family);
xxv. Guttiferae (St. John's-wort family);
xxvi. Haloragaceae (watermilfoil family);
xxvii. Hydrocharitaceae (frogbit family);
xxviii. Labiatae (also referred to as Lamiaceae; mint family);
xxix. Lamiaceae (also referred to as Labiatae);
xxx. Leguminosae (also referred to as Fabaceae; pea family);
xxxi. Liliaceae (lily family);
xxxii. Lythraceae (loosestrife family);
xxxiii. Malvaceae (mallow family);
xxxiv. Nyctaginaceae (four-o'clock family);
xxxv. Onagraceae (evening-primrose family);
xxxvi. Oxalidaceae (wood-sorrel family);
xxxvii. Plantaginaceae (plantain family);
xxxviii. Poaceae (also referred to as Gram ineae);
xxxix. Polygonaceae (buckwheat family);
xl. Pteridaceae (fern family);
xli. Portulacaceae (purslane family);
xlii. Ranunculaceae (buttercup family);
xliii. Rhamnaceae (buckthorn family);
xliv. Rosaceae (rose family);
xlv. Rubiaceae (madder family);
xlvi. Scrophulariaceae (figwort family);
xlvii. Solanaceae (nightshade family);
xlviii. Trapaceae (water-chestnut family);
xlix. Typhaceae (cattail family);
l. Umbelliferae (also referred to as Apiaceae; parsley family); and
li. Urticaceae (nettle family).

In at least one embodiment, the (N)R-1,4-naphthaquinone has a concentration in a range of about 0.1% to about 20% concentration by mass.

In at least one embodiment, the (N)R-1,4-naphthaquinone has a concentration in a range of about 0.1% to about 1.5% concentration by mass.

In at least one embodiment, the (N)R-1,4-naphthaquinone is N-hydroxy-1,4-naphthalenedione or an agriculturally acceptable salt thereof, wherein N is in the range of 2-5.

In at least one embodiment, the N-hydroxy-1,4-naphthalenedione is a compound of the formula:

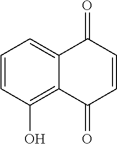 [SMILES: O=C1C=CC(=O)c2c(O)cccc21]

or an agriculturally acceptable salt thereof.

In at least one embodiment, the herbicidally effective amount of (N)R-1,4-naphthaquinone or an agriculturally acceptable salt thereof is in a range of about 200 grams per acre to about 2 kg per acre.

In another broad aspect, a method of controlling growth of plants is described herein. The method includes the steps of: applying to the plants or to an area adjacent to the plants or to soil or water that controls the emergence of the plants, a herbicidally effective amount of (N)R-1,4-naphthaquinone or an agriculturally acceptable salt thereof; wherein N is of the value 2-5 and R is a functional group, the functional group including any one of, or any combination of, the following functional groups:
i. alkane;
ii. alkene;
iii. alkyne;
iv. benzene;
v. amine;
vi. alcohol;
vii. ether;
viii. alkyl halide;
ix. thiol;
x. aldehyde;
xi. ketone;
xii. ester;
xiii. carboxylic acid;
xiv. amide; or
xv. hydroxyl.

In at least one embodiment of the method, the herbicidally effective amount of (N)R-1,4-naphthaquinone is applied, in herbicidally effective amounts:
i. directly to the emergent plant foliage and any exposed tissue, as a post-emergent application;
ii. directly to the soil, in anticipation of plant emergence, as a pre-emergent application;
iii. a combination of pre-emergent and post-emergent application.

In at least one embodiment of the method, the plants include at least one herbicide resistant weed.

In at least one embodiment of the method, the at least one herbicide resistant weed includes at least one glyphosate-based herbicide resistant weed.

In at least one embodiment of the method, the at least one herbicide resistant weed includes at least one herbicide resistant weed that is resistant to one or more of the following groups of herbicides:
i. Group 1: ACCase Inhibitors;
ii. Group 2: ACL Inhibitors;
iii. Group 3: Root Growth Inhibitors;
iv. Group 4: Plant Growth Regulators;
v. Group 5,6,7: Photosynthesis (PS III) Inhibitors;
vi. Group 8 and 15: Shoot Growth Inhibitors;
vii. Group 9: Aromatic Amino Acid Inhibitors;
viii. Group 10: Glutamine Synthesis Inhibitors;
ix. Group 12,23,37: Pigment Synthesis Inhibitors;
x. Group 14: PPO Inhibitors; and
xi. Group 22: Photosynthesis Inhibitors.

In at least one embodiment of the method, the at least one herbicide resistant weed includes a herbicide resistant weed of one or more of the following families of weeds:
i. Amaranthacaea (amaranth family);
ii. Anacardiaceae (poison-ivy family);
iii. Apiaceae (also referred to as Umbelliferae);
iv. Asclepiadaceae (milkweed family);
v. Asteraceae family (also referred to as Compositae);
vi. Balsaminaceae (touch-me-not family);
vii. Berberidaceae (barberry family);
viii. Boraginaceae (borage family);
ix. Brassicaceae (also referred to as Cruciferae);
x. Butomaceae (flowering rush family);
xi. Cannabaceae (cannabis family);
xii. Caprifoliaceae (honeysuckle family);
xiii. Caryophyllaceae (pink family);
xiv. Chenopodiaceae (goosefoot family);
xv. Compositae (composite family);
xvi. Convolvulaceae (morning-glory family);
xvii. Crassulaceae (orpine family);
xviii. Cruciferae (mustard family);
xix. Cucurbitaceae (cucumber family);
xx. Cyperaceae (sedge family);
xxi. Equisetaceae (horsetail family);
xxii. Euphorbiaceae (spurge family);
xxiii. Fabaceae (also referred to as Leguminosae);
xxiv. Gram ineae (also referred to as Poaceae; grass family);
xxv. Guttiferae (St. John's-wort family);
xxvi. Haloragaceae (watermilfoil family);
xxvii. Hydrocharitaceae (frogbit family);
xxviii. Labiatae (also referred to as Lamiaceae; mint family);
xxix. Lamiaceae (also referred to as Labiatae);
xxx. Leguminosae (also referred to as Fabaceae; pea family);
xxxi. Liliaceae (lily family);
xxxii. Lythraceae (loosestrife family);
xxxiii. Malvaceae (mallow family);
xxxiv. Nyctaginaceae (four-o'clock family);
xxxv. Onagraceae (evening-primrose family);
xxxvi. Oxalidaceae (wood-sorrel family);
xxxvii. Plantaginaceae (plantain family);
xxxviii. Poaceae (also referred to as Gramineae);
xxxix. Polygonaceae (buckwheat family);
xl. Pteridaceae (fern family);
xli. Portulacaceae (purslane family);
xlii. Ranunculaceae (buttercup family);
xliii. Rhamnaceae (buckthorn family);
xliv. Rosaceae (rose family);
xlv. Rubiaceae (madder family);
xlvi. Scrophulariaceae (figwort family);
xlvii. Solanaceae (nightshade family);
xlviii. Trapaceae (water-chestnut family);
xlix. Typhaceae (cattail family);
l. Umbelliferae (also referred to as Apiaceae; parsley family); and
li. Urticaceae (nettle family).

In at least one embodiment of the method, the (N)R-1,4-naphthaquinone has a concentration in a range of about 0.1% to about 20% concentration by mass.

In at least one embodiment of the method, the (N)R-1,4-naphthaquinone has a concentration in a range of about 0.1% to about 1.5% concentration by mass.

In at least one embodiment of the method, the (N)R-1,4-naphthaquinone is N-hydroxy-1,4-naphthalenedione or an agriculturally acceptable salt thereof, wherein N is in the range of 2-5.

In at least one embodiment of the method, the herbicidally effective amount of (N)R-1,4-naphthaquinone or an agriculturally acceptable salt thereof is in a range of about 200 grams per acre to about 2 kg per acre.

In at least one embodiment of the method, the N-hydroxy-1,4-naphthalenedione is a compound of the formula:

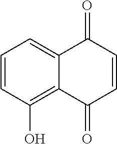 [SMILES: O=C1C=CC(=O)c2c(O)cccc21]

or an agriculturally acceptable salt thereof.

Additional aspects will be apparent in view of the description that follows. It should be understood however that the detailed description and the specific examples, while indicating preferred embodiments, are given by way of illustration only, since various changes and modifications will become apparent to those skilled in the art from this detailed description.

### BRIEF DESCRIPTION OF THE DRAWINGS

The drawings included herewith are for illustrating various examples of articles, methods, and apparatuses of the present specification. In the drawings:

FIG. 1 is a picture of three pots showing 7 day growth of Amaranthus powelli (Powell's Amaranth), Group 2,5 resistant, when left untreated, treated with 1% Juglone, and treated with a control (i.e. solvent/surfactant, no active ingredient), respectively.

FIG. 2 is a picture of three pots showing 7 day growth of Amaranthus rudis JD Sauer (Waterhemp), Group 2,4,5,14,9,27 Resistant, when left untreated, treated with 1% Juglone, and treated with a control (i.e. solvent/surfactant, no active ingredient), respectively.

FIG. 3 is a picture of three pots showing 7 day growth of Amaranthus rudis JD Sauer (Waterhemp), non-resistant, when left untreated, treated with 1% Juglone, and treated with a control (i.e. solvent/surfactant, no active ingredient), respectively.

FIG. 4 is a picture of three pots showing 7 day growth of Chenopodium album L. (lamb's quarters), Group 2,5 Resistant, when left untreated, treated with 1% Juglone, and treated with a control (i.e. solvent/surfactant, no active ingredient), respectively.

FIG. 5 is a picture of two pots showing 7 day growth of Amaranthus retroflexusLL. (pigweed), Group 2,5 Resistant, when left untreated and treated with 1% Juglone, respectively.

FIG. 6 is a picture of two pots showing 7 day growth of Solanum ptycanthum (eastern black nightshade), Group 2 Resistant, when left untreated and treated with 1% Juglone, respectively.

FIG. 7 is a picture of three pots showing 7 day growth of Amaranthus hybridus L. (smooth pigweed), Group 2,5 Resistant, when left untreated, treated with 1% Juglone, and treated with a control (i.e. solvent/surfactant, no active ingredient), respectively.

### DETAILED DESCRIPTION

Various compositions and methods will be described below to provide an example of one or more embodiments. No embodiment described below limits any claimed embodiment and any claimed embodiment may cover compositions or methods that differ from those described below. The claimed embodiments are not limited to compositions or methods having all of the features of any one composition or method described below or to features common to multiple or all of the compositions and methods described below. It is possible that a composition or method described below is not an embodiment of any claimed embodiment. Any embodiment disclosed below that is not claimed in this document may be the subject matter of another protective instrument, for example, a continuing patent application, and the applicants, inventors or owners do not intend to abandon, disclaim or dedicate to the public any such embodiment by its disclosure in this document.

The present disclosure relates to herbicidal compositions comprising a herbicidally effective amount of (N)R-1,4-naphthaquinone or an agriculturally acceptable salt thereof. The present disclosure also relates to methods for controlling (i.e. preventing, combating, suppressing inhibiting or eradicating) growth of plants, such as but not limited to undesirable vegetation including weeds and/or herbicide resistant weeds.

The term “plants”, as used herein, means any living thing that grows in earth, in water, or on other plants. Plants usually have a stem, leaves, roots, and flowers, and produce seeds.

The term “flowering plants”, also known as angiosperms, as used herein, means a group of seed-producing land plants that are distinguished from gymnosperms by characteristics including flowers, endosperm within the seeds, and the production of fruits that contain the seeds. Etymologically, angiosperm means a plant that produces seeds within an enclosure; in other words, a fruiting plant.

The term “undesirable vegetation”, as used herein, refers to refers to any unwanted vegetation including seeds, seedlings and germinated plants. Undesirable vegetation as used herein includes weeds.

The term “weed”, as used herein, means a plant considered undesirable in a particular situation, or a plant in the wrong place. Examples of weeds include but are not limited to plants unwanted in human-controlled settings, such as but not limited to farm fields, gardens, lawns, and parks.

The term “herbicide,” as used herein, means an active ingredient that kills, controls, or otherwise adversely modifies the growth of vegetation. A “herbicidally effective amount” is an amount of an active ingredient that causes a “herbicidal effect,” i.e., an adversely modifying effect and includes deviations from, for instance, natural development, killing, regulation, desiccation, and retardation.

The terms “plants” and “vegetation”, as used herein, can include, for instance, germinant seeds, emerging seedlings, and established vegetation.

The term “herbicide resistant weed” or “herbicide tolerant weed”, as used herein, means a weed that has acquired the genetic capacity to survive a herbicide treatment that, under normal use conditions, would effectively control that weed population.

Herbicide compositions of the present disclosure include (N)R-1,4-naphthaquinone, wherein N is in the range of 2-5 and R is a functional group. The functional group may include any one of, or any combination of, the following functional groups: alkanes, alkenes, alkynes benzenes, amines, alcohols, ethers, alkyl halides, thiols, aldehydes, ketones, esters, carboxylic acids, amides and/or hydroxyls.

In at least one embodiment, the (N)R-1,4-naphthaquinone can be an agriculturally acceptable salt of (N)R-1,4-naphthaquinone. Exemplary agriculturally acceptable salts of (N)R-1,4-naphthaquinone can include, but are not limited to, sodium salts, potassium salts, ammonium salts or substituted ammonium salts, in particular mono-, di- and tri-C1-C8-alkylammonium salts such as methylammonium, dimethylammonium and isopropylammonium, mono-, di- and tri-hydroxy-C2-C8-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, olamine salts, and diglycolamine salts.

In at least one embodiment, herbicide compositions of the present disclosure include the compound of formula (I), 5-hydroxy-1,4-naphthalenedione (e.g. Juglone). Juglone occurs naturally in the leaves, roots, husks, fruit (e.g. the epicarp), and bark of plants in the Juglandaceae family, particularly the black walnut (Juglans nigra).

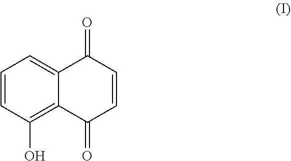 [SMILES: O=C1C=CC(=O)c2c(O)cccc21]

Compositions of the present disclosure including (N)R-1,4-naphthaquinone, or an agriculturally acceptable salt thereof, can be applied to vegetation, or an area adjacent the vegetation or applied to soil or water to prevent the emergence or growth of vegetation in an amount sufficient to induce a herbicidal effect.

Compositions of the present disclosure including (N)R-1,4-naphthaquinone, or an agriculturally acceptable salt thereof, can be applied directly to emergent plant foliage and any exposed tissue, as a post-emergent application, directly to soil, in anticipation of plant emergence, as a pre-emergent application, and/or as a combination of pre-emergent and post-emergent application.

In at least one embodiment, the compositions of the present disclosure including (N)R-1,4-naphthaquinone or an agriculturally acceptable salt thereof are applied to vegetation or an area adjacent the vegetation or applied to soil or water to prevent the emergence or growth of vegetation, wherein the composition has a concentration of (N)R-1,4-naphthaquinone in a range of about at 200 g/acre to about 2 kg/acre.

In at least one embodiment, the compositions of the present disclosure including (N)R-1,4-naphthaquinone or an agriculturally acceptable salt thereof are applied to vegetation or an area adjacent the vegetation or applied to soil or water to prevent the emergence or growth of vegetation, wherein the composition has a concentration of (N)R-1,4-naphthaquinone in a range of about at 200 g/acre to about 1 kg/acre.

In at least one embodiment, the compositions of the present disclosure including (N)R-1,4-naphthaquinone or an agriculturally acceptable salt thereof are applied to vegetation or an area adjacent the vegetation or applied to soil or water to prevent the emergence or growth of vegetation, wherein the herbicide composition is applied at a rate in a range of about at 200 g of (N)R-1,4-naphthaquinone per acre to about 2 kg of (N)R-1,4-naphthaquinone per acre.

In at least one embodiment, the compositions of the present disclosure including (N)R-1,4-naphthaquinone or an agriculturally acceptable salt thereof are applied to vegetation or an area adjacent the vegetation or applied to soil or water to prevent the emergence or growth of vegetation, wherein the herbicide composition is applied at a rate in a range of about at 200 g of (N)R-1,4-naphthaquinone per acre to about 1 kg of (N)R-1,4-naphthaquinone per acre.

In at least one embodiment, the compositions of the present disclosure including (N)R-1,4-naphthaquinone or an agriculturally acceptable salt thereof are applied to herbicide resistant plants.

In at least one embodiment, the compositions of the present disclosure including (N)R-1,4-naphthaquinone or an agriculturally acceptable salt thereof are applied to herbicide resistant weeds.

In at least one embodiment, the compositions of the present disclosure including (N)R-1,4-naphthaquinone or an agriculturally acceptable salt thereof are applied to herbicide resistant plants, and more specifically to herbicide resistant plants that are resistant to glyphosate-based herbicides, such as but not limited to Roundup®.

In at least one embodiment, the compositions of the present disclosure including (N)R-1,4-naphthaquinone or an agriculturally acceptable salt thereof are applied to herbicide resistant weeds, and more specifically to herbicide resistant weeds that are resistant to glyphosate-based herbicides, such as but not limited to Roundup®.

In at least one embodiment, the compositions of the present disclosure including (N)R-1,4-naphthaquinone or an agriculturally acceptable salt thereof are applied to plants including one or more of the following families of flowering plants (terms in brackets are common names of the families): Amaranthacaea (amaranth family), Anacardiaceae (poison-ivy family), Apiaceae (also referred to as Umbelliferae), Asclepiadaceae (milkweed family), Asteraceae family (also referred to as Compositae), Balsaminaceae (touch-me-not family), Berberidaceae (barberry family), Boraginaceae (borage family), Brassicaceae (also referred to as Cruciferae), Butomaceae (flowering rush family), Cannabaceae (cannabis family), Caprifoliaceae (honeysuckle family), Caryophyllaceae (pink family), Chenopodiaceae (goosefoot family), Compositae (composite family), Convolvulaceae (morning-glory family), Crassulaceae (orpine family), Cruciferae (mustard family), Cucurbitaceae (cucumber family), Cyperaceae (sedge family), Equisetaceae (horsetail family), Euphorbiaceae (spurge family), Fabaceae (also referred to as Leguminosae), Gramineae (also referred to as Poaceae; grass family), Guttiferae (St. John's-wort family), Haloragaceae (watermilfoil family), Hydrocharitaceae (frogbit family), Labiatae (also referred to as Lamiaceae; mint family), Lamiaceae (also referred to as Labiatae), Leguminosae (also referred to as Fabaceae; pea family), Liliaceae (lily family), Lythraceae (loosestrife family), Malvaceae (mallow family), Nyctaginaceae (four-o'clock family), Onagraceae (evening-primrose family), Oxalidaceae (wood-sorrel family), Plantaginaceae (plantain family), Poaceae (also referred to as Gramineae), Polygonaceae (buckwheat family), Pteridaceae (fern family), Portulacaceae (purslane family), Ranunculaceae (buttercup family), Rhamnaceae (buckthorn family), Rosaceae (rose family), Rubiaceae (madder family), Scrophulariaceae (figwort family), Solanaceae (nightshade family), Trapaceae (water-chestnut family), Typhaceae (cattail family), Umbelliferae (also referred to as Apiaceae; parsley family) and Urticaceae (nettle family).

In at least one embodiment, the compositions of the present disclosure including (N)R-1,4-naphthaquinone or an agriculturally acceptable salt thereof are applied to herbicide resistant weeds, including but not limited to herbicide resistant weeds of one or more of the following families (terms in brackets are common names of the families): Amaranthacaea (amaranth family), Anacardiaceae (poison-ivy family), Apiaceae (also referred to as Umbelliferae), Asclepiadaceae (milkweed family), Asteraceae family (also referred to as Compositae), Balsaminaceae (touch-me-not family), Berberidaceae (barberry family), Boraginaceae (borage family), Brassicaceae (also referred to as Cruciferae), Butomaceae (flowering rush family), Cannabaceae (cannabis family), Caprifoliaceae (honeysuckle family), Caryophyllaceae (pink family), Chenopodiaceae (goosefoot family), Compositae (composite family), Convolvulaceae (morning-glory family), Crassulaceae (orpine family), Cruciferae (mustard family), Cucurbitaceae (cucumber family), Cyperaceae (sedge family), Equisetaceae (horsetail family), Euphorbiaceae (spurge family), Fabaceae (also referred to as Leguminosae), Gramineae (also referred to as Poaceae; grass family), Guttiferae (St. John's-wort family), Haloragaceae (watermilfoil family), Hydrocharitaceae (frogbit family), Labiatae (also referred to as Lamiaceae; mint family), Lamiaceae (also referred to as Labiatae), Leguminosae (also referred to as Fabaceae; pea family), Liliaceae (lily family), Lythraceae (loosestrife family), Malvaceae (mallow family), Nyctaginaceae (four-o'clock family), Onagraceae (evening-primrose family), Oxalidaceae (wood-sorrel family), Plantaginaceae (plantain family), Poaceae (also referred to as Gramineae), Polygonaceae (buckwheat family), Pteridaceae (fern family), Portulacaceae (purslane family), Ranunculaceae (buttercup family), Rhamnaceae (buckthorn family), Rosaceae (rose family), Rubiaceae (madder family), Scrophulariaceae (figwort family), Solanaceae (nightshade family), Trapaceae (water-chestnut family), Typhaceae (cattail family), Umbelliferae (also referred to as Apiaceae; parsley family) and Urticaceae (nettle family).

In at least one embodiment, the compositions of the present disclosure including (N)R-1,4-naphthaquinone or an agriculturally acceptable salt thereof are applied to plants including herbicide resistant plants that are resistant to herbicides of one or more of the following groups: Group 1: ACCase Inhibitors, Group 2: ACL Inhibitors, Group 3: Root Growth Inhibitors, Group 4: Plant Growth Regulators, Group 5,6,7: Photosynthesis (PSIII) Inhibitors, Group 8 and 15: Shoot Growth Inhibitors, Group 9: Aromatic Amino Acid Inhibitors, Group 10: Glutamine Synthesis Inhibitors, Group 12,23,37: Pigment Synthesis Inhibitors, Group 14: PPO Inhibitors and Group 22: Photosynthesis Inhibitors.

In at least one embodiment, the compositions of the present disclosure including (N)R-1,4-naphthaquinone or an agriculturally acceptable salt thereof are applied to plants at a concentration in a range of about 0.1% to about 20% concentration by mass.

In at least one embodiment, the compositions of the present disclosure including (N)R-1,4-naphthaquinone or an agriculturally acceptable salt thereof are applied to plants at a concentration in a range of about 0.1% to about 10% concentration by mass.

In at least one embodiment, the compositions of the present disclosure including (N)R-1,4-naphthaquinone or an agriculturally acceptable salt thereof are applied to plants at a concentration in a range of about 0.1% to about 1.5% concentration by mass.

In at least one embodiment, the compositions of the present disclosure including (N)R-1,4-naphthaquinone or an agriculturally acceptable salt thereof are applied to cut stumps at a concentration in a range of about 1% to about 20% concentration by mass.

In at least one embodiment, the compositions of the present disclosure including (N)R-1,4-naphthaquinone or an agriculturally acceptable salt thereof are applied to pre-emergent or post-emergent plants at a concentration in a range of about 0.1% to about 1.5% concentration by mass.

The compositions disclosed herein can also be mixed with or applied with one or more additives. In at least one embodiment, the additive can be diluted in water or can be concentrated. In at least one embodiment, the additive is added sequentially. In at least one embodiment, the additive is added simultaneously. In at least one embodiment, the additive is premixed with the (N)R-1,4-naphthaquinone or agriculturally acceptable salt thereof.

In at least one embodiment, the additive includes one or more agriculturally acceptable adjuvants. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof. Exemplary agriculturally acceptable adjuvants include, but are not limited to, crop oil concentrate (mineral oil (85%)+emulsifiers (15%)) or less, nonylphenol ethoxylate or less, benzylcocoalkyldimethyl quaternary ammonium salt or less, blend of petroleum hydrocarbon, alkyl esters, organic acid, and anionic surfactant or less, C₉-C₁₁alkylpolyglycoside or less, phosphate alcohol ethoxylate or less, natural primary alcohol (C₁₂-C₁₆) ethoxylate or less, di-sec-butylphenol EO-PO block copolymer or less, polysiloxane-methyl cap or less, nonylphenol ethoxylate+urea ammonium nitrate or less, emulsified methylated seed oil or less, tridecyl alcohol (synthetic) ethoxylate (8 EO) or less, tallow amine ethoxylate (15 EO) or less, and PEG(400) dioleate-99.

Exemplary surfactants (e.g., wetting agents, tackifiers, dispersants, emulsifiers) include, but are not limited to, one or more of the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof. In at least one embodiment, the surfactant includes Hallcomid 1025.

Exemplary thickeners include, but are not limited to, one or more polysaccharides, such as xanthan gum, and organic and inorganic sheet minerals, and mixtures thereof.

Exemplary antifoam agents include, but are not limited to, one or more silicone emulsions, long-chain alcohols, fatty acids, salts of fatty acids, organofluorine compounds, and mixtures thereof.

Exemplary antimicrobial agents include, but are not limited to, one or more bactericides based on dichlorophen and benzyl alcohol hemiformal, and isothiazolinone derivates, such as alkylisothiazolinones and benzisothiazolinones, and mixtures thereof.

Exemplary antifreeze agents, include, but are not limited to, one or more ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

### Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In at least one embodiment, the method of application can be chosen to ensure the finest possible distribution of the compositions disclosed herein.

The compositions disclosed herein can be applied pre-emergence (before the emergence of undesirable vegetation (e.g. weeds)) or post-emergence (i.e., during and/or after emergence of the undesirable vegetation (e.g. weeds) including but not limited to after mechanical cutting of the vegetation (e.g. to a cut stump)).

In at least one embodiment, the compositions disclosed herein are applied to undesirable vegetation (e.g. weeds) or an area adjacent the undesirable vegetation or applied to soil or water to prevent the emergence or growth of undesirable vegetation by spraying (e.g. foliar spraying). In at least one embodiment, the spraying techniques use, for example, water as a carrier.

In at least one embodiment, herbicidal activity is exhibited by the compositions described herein when they are applied directly to the undesirable vegetation (e.g. weeds) or to the locus of the undesirable vegetation at any stage of growth or before emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of the herbicide composition applied.

The compositions and methods disclosed herein can be used for controlling undesired vegetation (e.g. weeds including but not limited to herbicide resistant weeds) in non-crop areas. Exemplary non-crop areas include, but are not limited to, turfgrass, pastures, grasslands, rangelands, fallow land, rights-of-way, aquatic settings, tree and vine, wildlife management areas, or rangeland. In at least one embodiment, the compositions and methods disclosed herein can also be used in forestry (e.g., for site preparation or for combating undesirable vegetation in plantation forests). In at least one embodiment, the compositions and methods disclosed herein can be used to control undesirable vegetation in conservation reserve program lands (CRP), trees, vines, grasslands, and grasses grown for seeds. In at least one embodiment, the compositions and methods disclosed herein can be used on lawns (e.g., residential, industrial, and institutional), golf courses, parks, cemeteries, athletic fields, and sod farms.

The compositions and methods described herein may be used for controlling the growth of undesired vegetation (e.g. weeds including but not limited to herbicide resistant weeds) in crop areas, such as but not limited to areas of growth crops of wheat, barley, rice, corn, sunflowers, soybeans and cotton. In at least one embodiment, the compositions described herein do not cause any significant damage to crop plants.

The compositions and methods described herein may be used for controlling the growth of herbicide resistant weeds (e.g. weeds resistant to glyphosate-based herbicides) in agricultural settings such as but not limited to the growth of herbicide resistant weeds (e.g. weeds resistant to glyphosate-based herbicides) growing amongst one or more crop plants. The one or more crop plants may include but are not limited to row crop plants, a fruit, a vegetable, a tree, or an ornamental plant. For example, in at least one embodiment disclosed herein, the crop plants include a row crop plant (e.g., corn, soybean, cotton, canola, sugar beet, alfalfa, sugarcane, rice, and wheat), or is a vegetable (e.g., tomato, sweet pepper, hot pepper, melon, watermelon, cucumber, eggplant, cauliflower, broccoli, lettuce, spinach, onion, peas, carrots, sweet corn, Chinese cabbage, leek, fennel, pumpkin, squash or gourd, radish, Brussels sprouts, tomatillo, garden beans, dry beans, or okra), or is an culinary plant (e.g., basil, parsley, coffee, or tea,), or is a fruit (e.g., apple, pear, cherry, peach, plum, apricot, banana, plantain, table grape, wine grape, citrus, avocado, mango, or berry), or is a tree grown for ornamental or commercial use (e.g., a fruit or nut tree, or is an ornamental plant (e.g., an ornamental flowering plant or shrub or turf grass).

In at least one embodiment, the compositions described herein induce damage one or more cells of the undesired vegetation such as by damaging the cellular membrane of one or more cells of the undesired vegetation.

While the above description provides examples of one or more apparatus, methods, or systems, it will be appreciated that other apparatus, methods, or systems may be within the scope of the claims as interpreted by one of skill in the art.

By way of non-limiting illustration, examples of certain embodiments of the present disclosure are given below.

### EXAMPLES

Referring now to the figures, pictures of various weeds are shown herein after being treated with an herbicide composition described herein. In all of the pictures provided herein, weeds that were about 0-2 weeks post emergent (e.g. about 2-5 cm in height) were treated with an herbicide composition having a 1% Juglone concentration. In most cases, plant damage was observed within two hours of treatment of the weeds with the herbicide composition.

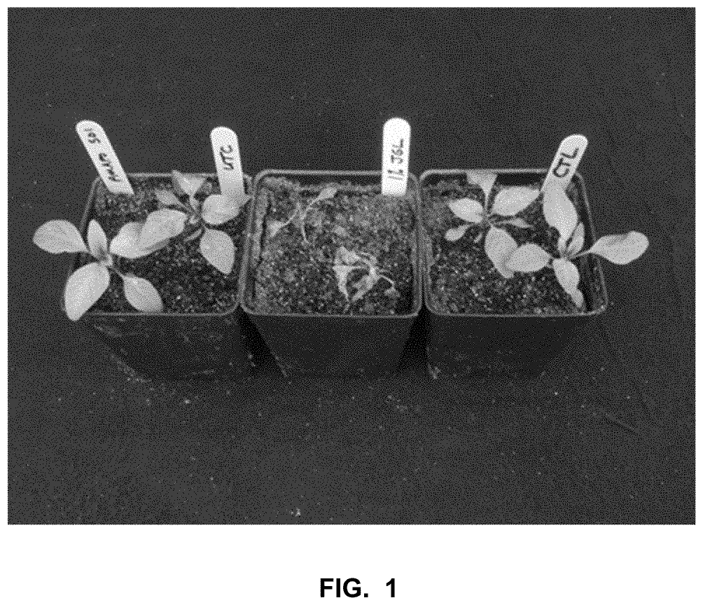

Specifically, FIG. 1 is a picture of three pots showing 7 day growth of Amaranthus powelli (Powell's Amaranth), Group 2,5 resistant, when left untreated, treated with 1% Juglone, and treated with a control (i.e. solvent/surfactant, no active ingredient), respectively.

As is shown in FIG. 1, application of 1% Juglone effectively controlled the growth of Amaranthus powelli 7 days after treatment.

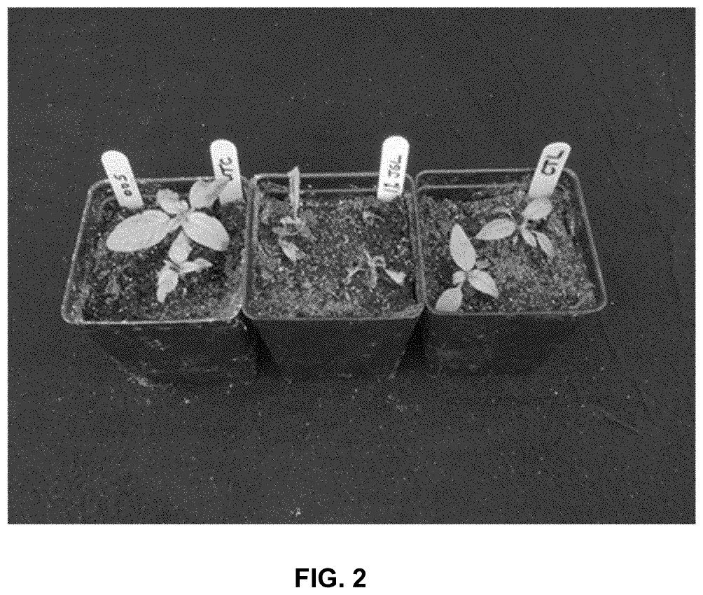

FIG. 2 is a picture of three pots showing 7 day growth of Amaranthus rudis JD Sauer (Waterhemp), Group 2,4,5,14,9,27 Resistant, when left untreated, treated with 1% Juglone, and treated with a control (i.e. solvent/surfactant, no active ingredient), respectively.

As is shown in FIG. 1, application of 1% Juglone effectively controlled the growth of Amaranthus rudis JD Sauer (Waterhemp), Group 2,4,5,14,9,27 Resistant, 7 days after treatment.

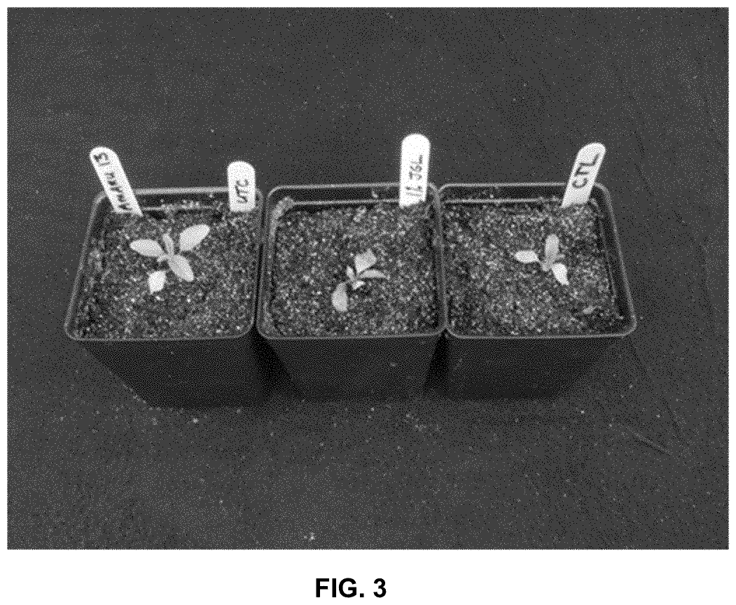

FIG. 3 is a picture of three pots showing 7 day growth of Amaranthus rudis JD Sauer (Waterhemp), non-resistant, when left untreated, treated with 1% Juglone, and treated with a control (i.e. solvent/surfactant, no active ingredient), respectively.

As is shown in FIG. 3, application of 1% Juglone did not effectively control the growth of Amaranthus rudis JD Sauer (Waterhemp), non-resistant, 7 days after treatment.

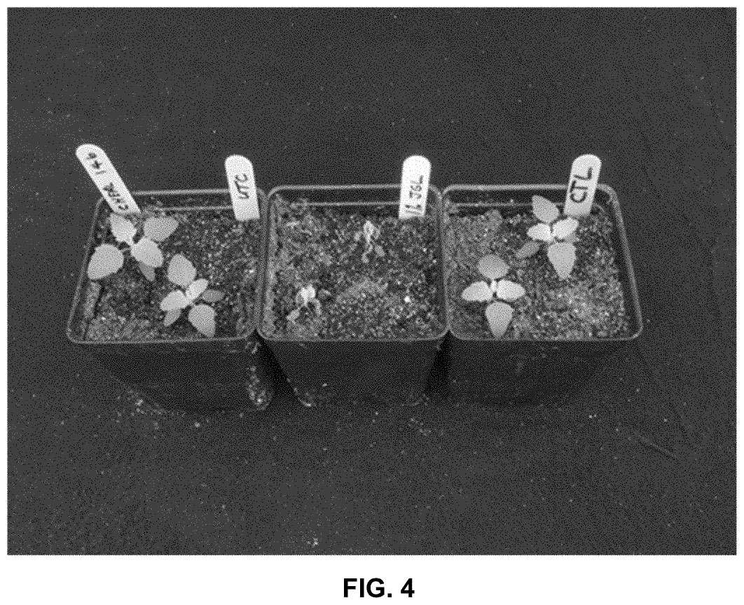

FIG. 4 is a picture of three pots showing 7 day growth of Chenopodium album L. (lamb's quarters), Group 2,5 Resistant, when left untreated, treated with 1% Juglone, and treated with a control (i.e. solvent/surfactant, no active ingredient), respectively.

As is shown in FIG. 4, application of 1% Juglone effectively controlled the growth of Chenopodium album L. (lamb's quarters), Group 2,5 Resistant, 7 days after treatment.

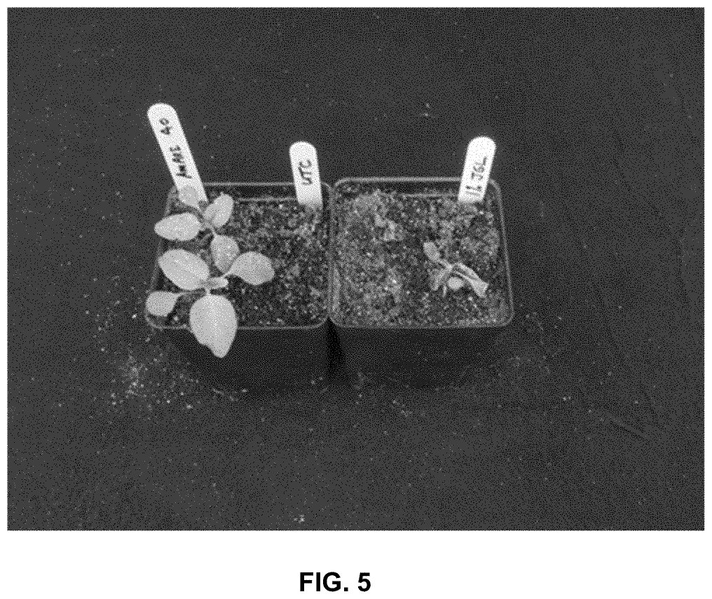

FIG. 5 is a picture of two pots showing 7 day growth of Amaranthus retroflexus L. (pigweed), Group 2,5 Resistant, when left untreated and treated with 1% Juglone, respectively.

As is shown in FIG. 5, application of 1% Juglone effectively controlled the growth of Amaranthus retroflexus L. (pigweed), Group 2,5 Resistant, 7 days after treatment.

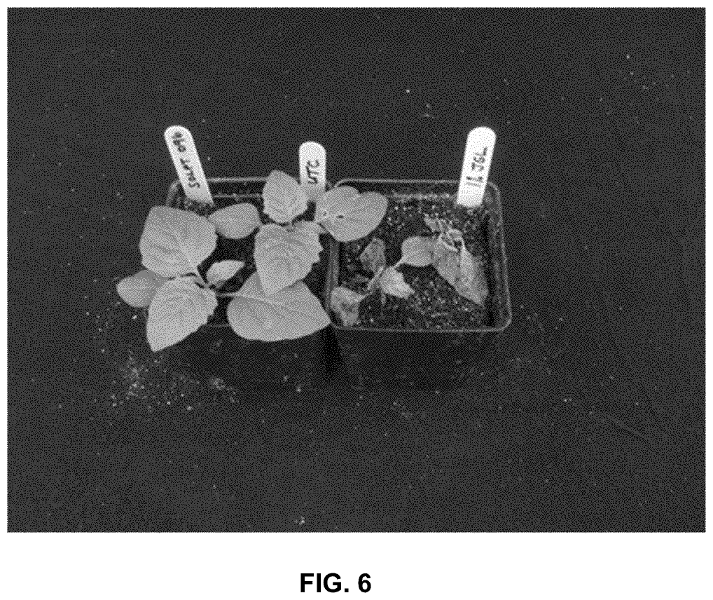

FIG. 6 is a picture of two pots showing 7 day growth of Solanum ptycanthum (eastern black nightshade), Group 2 Resistant, when left untreated and treated with 1% Juglone, respectively.

As is shown in FIG. 6, application of 1% Juglone effectively controlled the growth of Solanum ptycanthum (eastern black nightshade), Group 2 Resistant, 7 days after treatment.

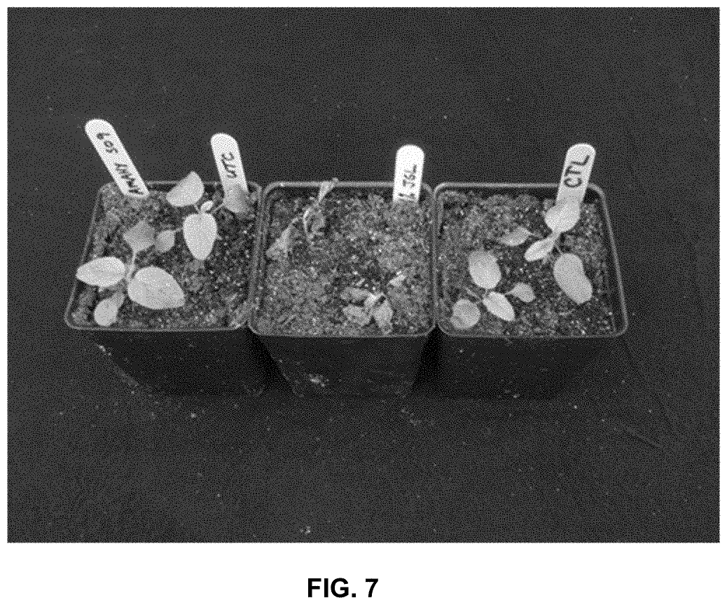

FIG. 7 is a picture of three pots showing 7 day growth of Amaranthus hybridus L. (smooth pigweed), Group 2,5 Resistant, when left untreated, treated with 1% Juglone, and treated with a control (i.e. solvent/surfactant, no active ingredient), respectively.

As is shown in FIG. 7, application of 1% Juglone effectively controlled the growth of Amaranthus hybridus L. (smooth pigweed), Group 2,5 Resistant, 7 days after treatment.

It should be noted that FIG. 3 shows that the herbicide composition with a 1% Juglone concentration did not control the growth of Amaranthus rudis JD Sauer (Waterhemp), non-resistant, 7 days after treatment, whereas the same herbicide composition with a 1% Juglone concentration did control the growth of Amaranthus rudis JD Sauer (Waterhemp), Group 2,4,5,14,9,27 Resistant, 7 days after treatment.

While the above description provides examples of one or more apparatus, methods, or systems, it will be appreciated that other apparatus, methods, or systems may be within the scope of the claims as interpreted by one of skill in the art.

What is claimed is:

1. A herbicide composition effective in controlling growth of plants, the herbicide composition comprising a herbicidally effective amount of (N)R-1,4-naphthaquinone or an agriculturally acceptable salt thereof;
wherein N is of the value 2-5 and R is a functional group, the functional group including any one of, or any combination of, the following functional groups:
xvi. Alkane
xvii. Alkene
xviii. Alkyne
xix. Benzene
xx. Amine
xxi. Alcohol
xxii. Ether
xxiii. Alkyl Halide
xxiv. Thiol
xxv. Aldehyde
xxvi. Ketone
xxvii. Ester
xxviii. Carboxylic Acid
xxix. Amide
xxx. Hydroxyl.

2. The herbicide composition of claim 1, wherein the plants include undesirable vegetation.

3. The herbicide composition of claim 2, wherein the undesirable vegetation includes at least one herbicide resistant weed.

4. The herbicide composition of claim 3, wherein the at least one herbicide resistant weed includes at least one glyphosate-based herbicide resistant weed.

5. The herbicide composition of claim 3, wherein the at least one herbicide resistant weed includes at least one herbicide resistant weed that is resistant to one or more of the following groups of herbicides:
xii. Group 1: ACCase Inhibitors;
xiii. Group 2: ACL Inhibitors;
xiv. Group 3: Root Growth Inhibitors;
xv. Group 4: Plant Growth Regulators;
xvi. Group 5,6,7: Photosynthesis (PSIII) Inhibitors;
xvii. Group 8 and 15: Shoot Growth Inhibitors;
xviii. Group 9: Aromatic Amino Acid Inhibitors;
xix. Group 10: Glutamine Synthesis Inhibitors;
xx. Group 12,23,37: Pigment Synthesis Inhibitors;
xxi. Group 14: PPO Inhibitors; and
xxii. Group 22: Photosynthesis Inhibitors.

6. The herbicide composition of claim 3, wherein the at least one herbicide resistant weed includes a herbicide resistant weed of one or more of the following families of weeds:
xvi. Amaranthacaea (amaranth family);
xvii. Anacardiaceae (poison-ivy family);
xviii. Apiaceae (also referred to as Umbelliferae);
xix. Asclepiadaceae (milkweed family);
xx. Asteraceae family (also referred to as Compositae);
xxi. Balsaminaceae (touch-me-not family);
xxii. Berberidaceae (barberry family);
xxiii. Boraginaceae (borage family);
xxiv. Brassicaceae (also referred to as Cruciferae);
xxv. Butomaceae (flowering rush family);
xxvi. Cannabaceae (cannabis family);
xxvii. Caprifoliaceae (honeysuckle family);
xxviii. Caryophyllaceae (pink family);
xxix. Chenopodiaceae (goosefoot family);
xxx. Compositae (composite family);
xxxi. Convolvulaceae (morning-glory family);
xxxii. Crassulaceae (orpine family);
xxxiii. Cruciferae (mustard family);
xxxiv. Cucurbitaceae (cucumber family);
xxxv. Cyperaceae (sedge family);
xxxvi. Equisetaceae (horsetail family);
xxxvii. Euphorbiaceae (spurge family);
xxxviii. Fabaceae (also referred to as Leguminosae);
xxxix. Gram ineae (also referred to as Poaceae; grass family);
xl. Guttiferae (St. John's-wort family);
xli. Haloragaceae (watermilfoil family);
xlii. Hydrocharitaceae (frogbit family);
xliii. Labiatae (also referred to as Lamiaceae; mint family);
xliv. Lamiaceae (also referred to as Labiatae);
xlv. Leguminosae (also referred to as Fabaceae; pea family);
xlvi. Liliaceae (lily family);
xlvii. Lythraceae (loosestrife family);
xlviii. Malvaceae (mallow family);
xlix. Nyctaginaceae (four-o′clock family);
l. Onagraceae (evening-primrose family);
li. Oxalidaceae (wood-sorrel family);
lii. Plantaginaceae (plantain family);
liii. Poaceae (also referred to as Gramineae);
liv. Polygonaceae (buckwheat family);
lv. Pteridaceae (fern family);
lvi. Portulacaceae (purslane family);
lvii. Ranunculaceae (buttercup family);
lviii. Rhamnaceae (buckthorn family);
lix. Rosaceae (rose family);
lx. Rubiaceae (madder family);
lxi. Scrophulariaceae (figwort family);
lxii. Solanaceae (nightshade family);
lxiii. Trapaceae (water-chestnut family);
lxiv. Typhaceae (cattail family);
lxv. Umbelliferae (also referred to as Apiaceae; parsley family); and
lxvi. Urticaceae (nettle family).

7. The herbicide composition of claim 1, wherein the (N)R-1,4-naphthaquinone has a concentration in a range of about 0.1% to about 20% concentration by mass.

8. The herbicide composition of claim 1, wherein the herbicidally effective amount of (N)R-1,4-naphthaquinone or an agriculturally acceptable salt thereof is in a range of about 200 grams per acre to about 2 kg per acre.

9. The herbicide composition of claim 1, wherein the (N)R-1,4-naphthaquinone is N-hydroxy-1,4-naphthalenedione or an agriculturally acceptable salt thereof, wherein N is in the range of 2-5.

10. The herbicide composition of claim 1, wherein the N-hydroxy-1,4-naphthalenedione is a compound of the formula: 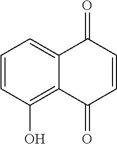 [SMILES: O=C1C=CC(=O)c2c(O)cccc21]
or an agriculturally acceptable salt thereof.

11. A method of controlling growth of plants, the method comprising the steps of:
applying to the plants or to an area adjacent to the plants or to soil or water that controls the emergence of the plants, a herbicidally effective amount of (N)R-1,4-naphthaquinone or an agriculturally acceptable salt thereof;
wherein N is of the value 2-5 and R is a functional group, the functional group including any one of, or any combination of, the following functional groups:
i. Alkane
ii. Alkene
iii. Alkyne
iv. Benzene
v. Amine
vi. Alcohol
vii. Ether
viii. Alkyl Halide
ix. Thiol
x. Aldehyde
xi. Ketone
xii. Ester
xiii. Carboxylic Acid
xiv. Amide
xv. Hydroxyl.

12. The method of claim 11, wherein the herbicidally effective amount of (N)R-1,4-naphthaquinone is applied, in herbicidally effective amounts:
iv. directly to the emergent plant foliage and any exposed tissue, as a post-emergent application;
v. directly to the soil, in anticipation of plant emergence, as a pre-emergent application;
vi. a combination of pre-emergent and post-emergent application.

13. The method of claim 11, wherein the plants include at least one herbicide resistant weed.

14. The method of claim 13, wherein the at least one herbicide resistant weed includes at least one glyphosate-based herbicide resistant weed.

15. The method of claim 13, wherein the at least one herbicide resistant weed includes at least one herbicide resistant weed that is resistant to one or more of the following groups of herbicides:
xii. Group 1: ACCase Inhibitors;
xiii. Group 2: ACL Inhibitors;
xiv. Group 3: Root Growth Inhibitors;
xv. Group 4: Plant Growth Regulators;
xvi. Group 5,6,7: Photosynthesis (PSIII) Inhibitors;
xvii. Group 8 and 15: Shoot Growth Inhibitors;
xviii. Group 9: Aromatic Amino Acid Inhibitors;
xix. Group 10: Glutamine Synthesis Inhibitors;
xx. Group 12,23,37: Pigment Synthesis Inhibitors;
xxi. Group 14: PPO Inhibitors; and
xxii. Group 22: Photosynthesis Inhibitors.

16. The method of claim 13, wherein the at least one herbicide resistant weed includes a herbicide resistant weed of one or more of the following families of weeds:
lii. Amaranthacaea (amaranth family);
liii. Anacardiaceae (poison-ivy family);
liv. Apiaceae (also referred to as Umbelliferae);
lv. Asclepiadaceae (milkweed family);
lvi. Asteraceae family (also referred to as Compositae);
lvii. Balsaminaceae (touch-me-not family);
lviii. Berberidaceae (barberry family);
lix. Boraginaceae (borage family);
lx. Brassicaceae (also referred to as Cruciferae);
lxi. Butomaceae (flowering rush family);
lxii. Cannabaceae (cannabis family);
lxiii. Caprifoliaceae (honeysuckle family);
lxiv. Caryophyllaceae (pink family);
lxv. Chenopodiaceae (goosefoot family);
lxvi. Compositae (composite family);
lxvii. Convolvulaceae (morning-glory family);
lxviii. Crassulaceae (orpine family);
lxix. Cruciferae (mustard family);
lxx. Cucurbitaceae (cucumber family);
lxxi. Cyperaceae (sedge family);
lxxii. Equisetaceae (horsetail family);
lxxiii. Euphorbiaceae (spurge family);
lxxiv. Fabaceae (also referred to as Leguminosae);
lxxv. Gram ineae (also referred to as Poaceae; grass family);
lxxvi. Guttiferae (St. John's-wort family);
lxxvii. Haloragaceae (watermilfoil family);
lxxviii. Hydrocharitaceae (frogbit family);
lxxix. Labiatae (also referred to as Lamiaceae; mint family);
lxxx. Lamiaceae (also referred to as Labiatae);
lxxxi. Leguminosae (also referred to as Fabaceae; pea family);
lxxxii. Liliaceae (lily family);
lxxxiii. Lythraceae (loosestrife family);
lxxxiv. Malvaceae (mallow family);
lxxxv. Nyctaginaceae (four-o'clock family);
lxxxvi. Onagraceae (evening-primrose family);
lxxxvii. Oxalidaceae (wood-sorrel family);
lxxxviii. Plantaginaceae (plantain family);
lxxxix. Poaceae (also referred to as Gramineae);
xc. Polygonaceae (buckwheat family);
xci. Pteridaceae (fern family);
xcii. Portulacaceae (purslane family);
xciii. Ranunculaceae (buttercup family);
xciv. Rhamnaceae (buckthorn family);
xcv. Rosaceae (rose family);
xcvi. Rubiaceae (madder family);
xcvii. Scrophulariaceae (figwort family);
xcviii. Solanaceae (nightshade family);
xcix. Trapaceae (water-chestnut family);
c. Typhaceae (cattail family);
ci. Umbelliferae (also referred to as Apiaceae; parsley family); and
cii. Urticaceae (nettle family).

17. The method of claim 11, wherein the (N)R-1,4-naphthaquinone has a concentration in a range of about 0.1% to about 20% concentration by mass.

18. The method of claim 11, wherein the herbicidally effective amount of (N)R-1,4-naphthaquinone or an agriculturally acceptable salt thereof is in a range of about 200 grams per acre to about 2 kg per acre.

19. The method of claim 11, wherein the (N)R-1,4-naphthaquinone is N-hydroxy-1,4-naphthalenedione or an agriculturally acceptable salt thereof, wherein N is in the range of 2-5.

20. The method of claim 11, wherein the N-hydroxy-1,4-naphthalenedione is a compound of the formula: 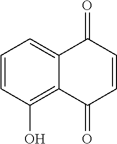 [SMILES: O=C1C=CC(=O)c2c(O)cccc21]
or an agriculturally acceptable salt thereof.
